(19) United States
(12) Patent Application Publication
(10) Pub. No.: US 2011/0089675 A1
(43) Pub. Date: Apr. 21, 2011

(54) COMPOSITION BOOK

(75) Inventors: Denise E. Sada, Centerville, OH (US); Bobby G. James, Jr., Miamisburg, OH (US)

(73) Assignee: MEADWESTVACO CORPORATION, Richmond, VA (US)

(21) Appl. No.: 12/996,808

(22) PCT Filed: Sep. 22, 2009
(86) PCT No.: PCT/US2009/057796

§ 371 Date: Dec. 8, 2010

Related U.S. Application Data
(60) Provisional application No. 61/099,775, filed on Sep. 24, 2008.

(51) Int. Cl. B42D 1/02; B42B 2/02

(52) U.S. Cl. 281/27; 412/7

(57) ABSTRACT

A composition book having a front and back cover and a plurality of pages stitched together wherein the plurality of pages may have hole punches and the front and back cover may have hole punches such as to allow the composition book to fit within a binder and wherein the plurality of pages are perforated such that they may be removed from the composition book.

### REFERENCE TO RELATED APPLICATION

This application claims the benefit of priority under 35 U.S.C. §119(e) of provisional application Ser. No. 61/099,775 filed on Sep. 24, 2008, which is hereby incorporated by reference in its entirety.

### BACKGROUND OF THE INVENTION

The present invention relates to a composition notebook and more particularly to a composition notebook having perforated pages.

### DESCRIPTION OF THE ART

Composition notebooks in their most general state consist of sheets folded in half and attached together by an attaching means such as staples or stitching or the like. Some composition books may have hard covers others may have soft covers or no cover at all. Books of this type (formed by a plurality of folded sheets) are well known in the art. Traditionally these books are used for labs in school, art sketch books, race books, crossword puzzle books or the like. Due to the nature of the books' simple construction, namely the folding of the plurality of pages to form an almost v-shape at the spine, the edges of the pages on the outside of the book do not perfectly line up with the edges of the pages in the middle of the book as a result this format is not ideal for removable pages due to the variation in page sizes. However, there is a need for a composition book format that is easily manufactured, has removable pages, but still maintains close to the same page size when the pages are removed from the book.

### SUMMARY OF THE INVENTION

The main objective of the invention is to provide a composition book with perforated pages wherein the page sizes of the removed pages vary only slightly depending upon the pages location in the book prior to removal. A composition book in accordance with the present invention may comprise more than one set of a plurality of sheets attached together by an attaching means wherein one set of a plurality of sheets is perforated at a predetermined distance from the centerline (stitching line) and another set of a plurality of sheets is perforated at a slightly greater pre-determined distance from said centerline. It is to be understood that such a variation in the perforations distance from the centerline may minimize the variation in page size caused by the folding of the sheets for the book's formation. It is to be understood that such a book may have a front and back cover. It is to be understood that holes may be drilled into the pages of the composition book such that the pages may be removed and added to a separate binder. It is to be further understood that holes may be drilled into the cover as well as the pages. Other objectives, advantages and novel features of the invention will become more apparent from the following detailed description.

### BRIEF DESCRIPTION OF THE FIGURES

FIGS. A & B are a plan view of two sets of sheets, indicating the page portion of the sheets, prior to their combination to form the composition book and presenting possible page and sheet dimensions.

FIG. 2 is a perspective view of an open composition book.

FIG. 3 is a perspective view of a composition book as it appears when opened to the first or last page.

### DETAILED DESCRIPTION OF THE PREFERRED EMBODIMENT

The composition book of the present invention may comprise a cover and more than one set (section) of a plurality of sheets wherein such plurality of sheets may be stitched together and may have perforations to form removable pages. It is to be further understood that the composition book or the pages of the composition book may have holes drilled such that the book or the pages may be placed into a binder. It is to be understood that a cover is not necessary for the claimed invention.

With reference to FIG. 1, the sheet 10 may be rectangular in dimension. It is to be understood that the sheet dimension may be square. It is to be understood that the sheet dimension may include sides that are shorter in length than the top and/or bottom. It is to be understood that the exact dimensions could be of any size based on manufacturing preferences. It is to be understood that the length of the top may be up to 40 inches, or up to 30 inches, or up to 20 inches, or up to 16 inches, or up to 10 inches, or up to 5 inches. It is to be understood that the length of the sides may be up to 40 inches, or up to 30 inches, or up to 20 inches, or up to 16 inches, or up to 11 inches, or up to 5 inches. It is to be understood that the corners of the sheets 10 may be shaped such that they match the corners of the cover 20. It is to be understood that the removable pages 28 are formed by the perforations 12 on either side of the center-line. It is to be understood that the sheet and page sizes are not limited to the dimensions shown in FIG. 1.

It is further to be understood that the sheets 10 may be lined. It is to be understood that the sheets 10 may be blank. It is to be understood that the sheets 10 may contain a grid. It is to be understood that the sheets 10 may be filled with pre-printed indicia. It is to be understood that other lines, tables etc may be pre-printed on the sheets 10.

The center-line 14 is located in the middle of sheet 10. It is to be understood that the centerline could be slightly off center if manufacturing preferences desired with only a slight effect on the removable pages 28 sizes. The plurality of sheets 10 are attached together along center-line 14 at attachment points 30. The plurality of sheets 10 may be attached together by stitching, staples or any other appropriate means to bind the sheets together along a center-line 14. When laid flat the center-line acts as the point of a V-shape 26 for the sheets 10. The composition book 18 folds at center-line 14.

The perforations 12 are located on either side of the center-line 14. The distance of the perforations 12 from the center-line 14 may be up to ¼ of an inch from the center-line 14, up to ⅓ of an inch from the center-line 14, up to ⅜ of an inch from the center-line 14, up to ½ of an inch from the center-line 14, up to ⅝ of an inch from the center-line 14, up to ¾ of an inch from the center-line 14, up to 1 inch from the center-line 14, up to 1.5 inches from the center-line 14, up to 2 inches from the center-line 14 or other distance that manufacturing preferences may dictate. It is to be understood that the desired location for the perforations 12 relative to the center-line 14 may depend upon the length and width of the notebook.

The plurality of sheets 10 may be divided into multiple sections 16. The sections 16 may include up to thirty sheets 10, up to twenty sheets 10, up to fifteen sheets 10, up to ten sheets 10, up to five sheets 10, up to three sheets 10. The number of sheets 10 appropriate for each section 16 may depend upon the sections location within the book 18. The outermost sections 16 of the book 18 may contain less sheets 10 in their sections 16 than the innermost sections 16. For example, the innermost sections 16 of the book 18 may contain sections 16 of 20 sheets 10, the next sections 16 may contain 15 sheets 10 and the outermost sections 16 may contain 10 sheets 10.

To keep the separated pages 28 about the same size as the other separated pages 28 from the composition book 18, the perforations 12 may be staggered or, in other words, the distance of the perforations 12 from the centerline 14 may vary between the various sheet sections 16. The distance of the perforations from center-line 14 may be up to ¼ of an inch, up to ⅓ of an inch, up to ½ of an inch, up to ¾ of an inch, up to 1 inch, up to 2 inches, up to 3 inches, or a manufacturing preferred combination of these distances.

The plurality of sheets 10 that make up the composition book may be divided into as many sections 16 as manufacturing preferences determine appropriate. For example, the plurality of sheets 10 may be divided into up to 6 sections 16, up to 4 sections 16, or up to 2 sections 16. The perforations 12 on the sheets 10 within in each section 16 may vary in distance from the centerline 14 as compared to another section 16 of sheets 10. The ratio of the variation in distance between the centerline 14 and the perforations 12 as compared between one or more sections 16 may be up to 3:4 ratio, up to 7:8 ratio, up to 1:2 ratio. For example, the innermost section 16 of sheets may have a perforation distance from the center-line 14 of 0.375 inches and the outermost section 16 of sheets may have a perforation distance from the center-line 14 of 0.5 inches, giving a ratio of 3:4 for the variation in distance of the perforations 12 from the center-line 14. Another section 16 of sheets could be added to the outside of the second sheet section 16 with a perforation distance from the center-line 14 of about 0.666 inches. It is to be understood that additional sections 16 may be added as well increasing the distance of the perforations 12 from the center-line 14 as the sections get further from the innermost section of the book 18.

The outermost section 16 may have the greatest distance between the center-line 14 and the perforations 12. The innermost section 16 may have the shortest distance between the center-line 14 and the perforations 12. The variations between the size of the pages 28 may be less than one inch, less than half an inch, less than a quarter of an inch, less than ⅛ of an inch, or less than 1/10 of an inch. The amount of variation that is acceptable between the pages 28 may be determined by manufacturing preferences.

It is to be understood that the composition book 18 may have hole punches 22 drilled into the book 18. It is to be understood that the cover 20 may have hole punches 22 such that the entire composition book 18 may be added to a binder. It is to be understood that only the pages 28 may have holes 22 drilled into them such that the pages 28 once removed from the composition book 18 may be added to a binder. It is to be understood that the holes 22 may be placed on the spine 24 side of the book 18 and/or pages 28. It is to be understood that the holes may be located along the top or bottom ends of the book 18 and/or sheets 10. It is to be understood that the holes 22 are positioned such that they fall within the parameters of the page 28 once removed from the composition book 18. It is further to be understood that the book 18 or pages 28 may have up to 10 holes, up to 8 holes, up to 6 holes, up to 3 holes, or up to 2 holes. It is to be understood that the number and location of these holes 22 may be determined by manufacturing preferences. It is to be understood that the holes 22 may be drilled prior to attaching the cover 20. It is to be understood that the holes 22 may be drilled after attaching the cover 20.

The cover 20 of the composition book 18 may be attached to the one or more sections 16 of sheets 10. The cover 20 of the composition book 18 may be attached using adhesive. The cover 20 of composition book 18 may be attached using stitching or staples or any other appropriate means. The cover 20 of the composition book 18 may be soft. The cover 20 of the composition book 18 may be composed of a stiff material. The cover 20 of the composition book 18 may be made of paperboard, treated paperboard, plastic, or plastic-like materials. The cover 20 of the composition book 18 may have an attachment to hold the book closed. Such an attachment may be a strap, a band, magnetic, or a snap or buckle type attachment. The cover of the composition book may be made to hold a writing instrument. The writing instrument may be held by a snap in or strap in or slide in type holder. The writing instrument holder may be a groove set in the cover 20 so as to allow a writing instrument to more easily and securely clip onto the outer cover.

It is to be understood that a similar result of maintaining close to the same removable page 28 size could be achieved by using sheets 10 that are slightly larger by sheet section 16 by similar ratios as the differences in perforation distances from center-line 14, namely up to 3:4, up to 7:8, or up to 1:2. It is too be understood that the larger sheets 10 should be on the outside and in such an instance the perforation 12 may still be staggered as described previously. Such a combination would further reduce the slight variation in the removable page 28 sizes, while still allowing for ease of removal from the bound composition book 18. However, it is understood that there are increased complexities involved with using different sized sheets that may make the manufacturing of a composition book by this means impractical from a manufacturing stand point. There is a recognized ease in manufacturing books using the same size sheets divided into the sections, perforated and attached together as described previously because only one size sheet is needed to be made, and a variety of sized sheets do not need to be combined by the manufacturing machines.

FIGS. 1A and B show two sample plurality of sheet sections 16 and example dimensions. As shown, the perforation line 12 varies in distance from center-line 14 between the two sheet sections 16. For example the sheet section 18 depicted in FIG. 1A may have a distance of about 0.375″ between the perforation line 12 and the center-line 14, while the sheet section 18 depicted in FIG. 1B may have a distance of about 0.5″ between the perforation line 12 and the center-line 14. In this example the second sheet section 16 depicted in FIG. 1B would be the outermost sheet section 16. The sheet section in FIG. 1A may be set atop the second sheet section 16 in FIG. 1B and the two attached together along center-line 14. A cover may be attached as well.

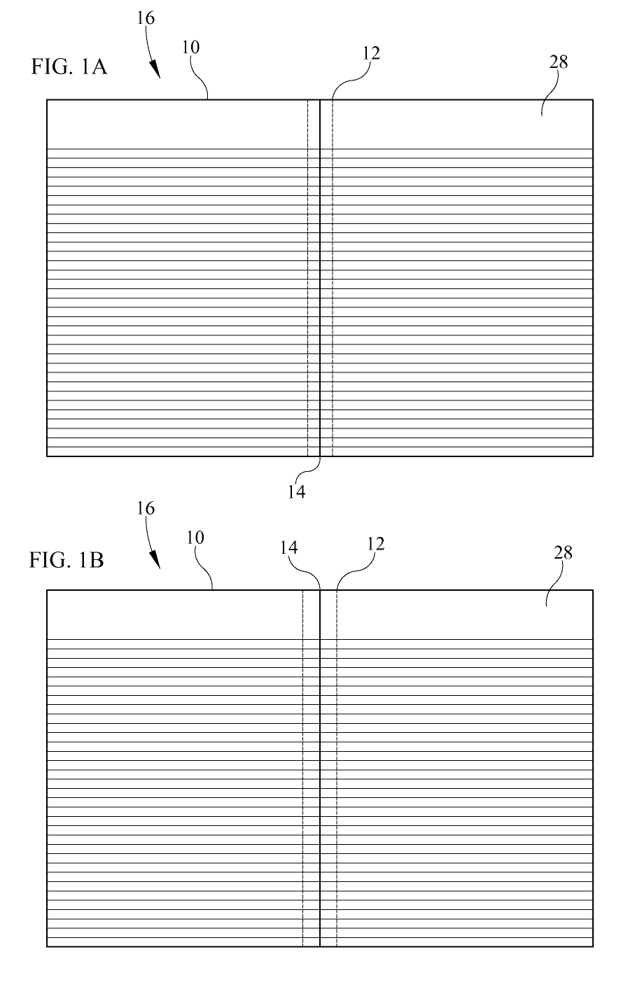

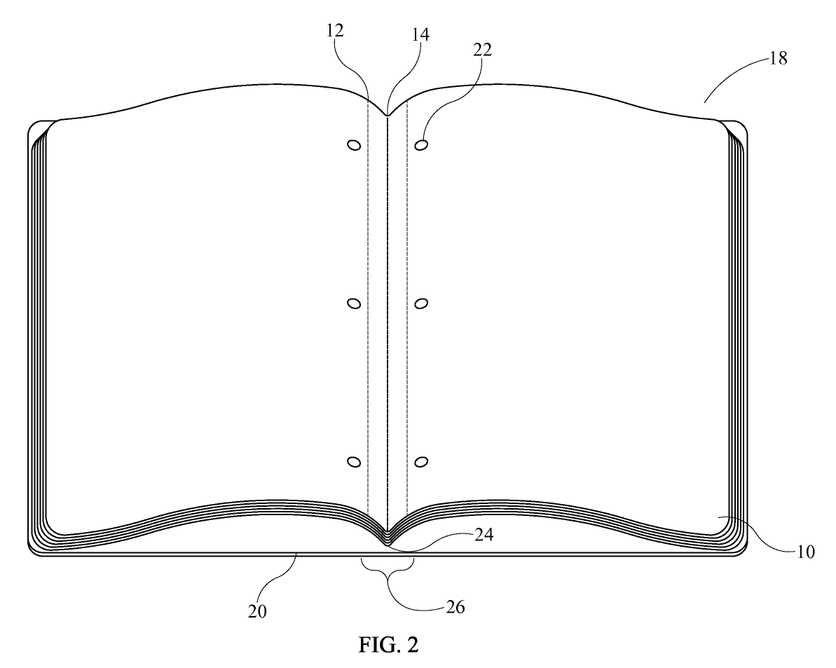

FIG. 2 shows an example of an open composition book 18 at center-line 14. Where the sheets are attached together along center-line 14 a v-shape 26 is formed at the spine 24 when in this open position.

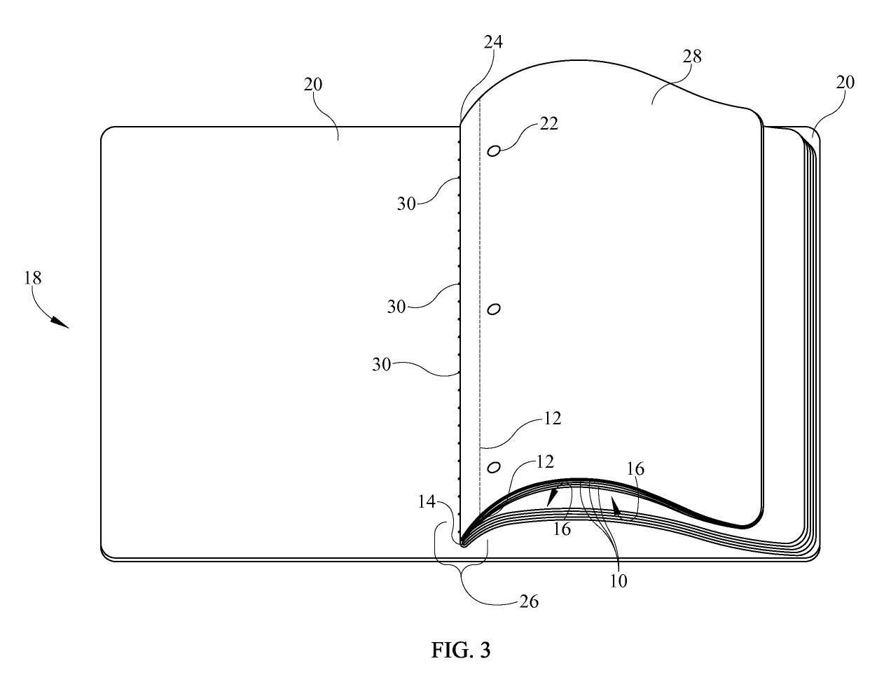

FIG. 3 shows an example of a composition book 18 open to its first page. Stitching 30 is shown along the spine 24 and in this example, depicts where the plurality of sheet sections 16 and cover 20 are attached together. The v-shape 26 is folded over and creates a small loop where center-line 14 has been folded upon itself.

Although various aspects of the disclosed packaging structures have been shown and described, modifications may occur to those skilled in the art upon reading the specification.

1. A composition book comprising:
(a) a front cover,
(b) a back cover,
(c) a first section of a plurality of pages, and
(d) a second section of a plurality of pages,
wherein said plurality of pages are stitched together, wherein said front cover and said back cover are attached to said first set of a plurality of pages and said second set of a plurality of pages, and wherein said first set of a plurality of pages and said second set of a plurality of pages have perforations such that the individual pages may be removed from the composition book.

2. The composition book of claim 1 wherein the front and back cover are stitched to the plurality of pages.

3. The composition book of claim 1 wherein the plurality of pages are lined.

4. The composition book of claim 1 wherein the plurality of pages have hole punches.

5. The composition book of claim 4 wherein the plurality of pages have three hole punches.

6. The composition book of claim 4 wherein the hole punches are located along the same side of the paper as the spine.

7. The composition book of claim 1 wherein the first set of a plurality of pages has perforations located up to ⅜ of an inch from the centerline.

8. The composition book of claim 7 wherein the first set of a plurality of pages is located in the middle of the composition binder.

9. The composition book of claim 1 wherein the second set of a plurality of pages has perforations located up to ½ an inch from the centerline.

10. The composition book of claim 9 wherein the second set of a plurality of pages is located on the outside of the first set of a plurality of pages.

11. A method of making a composition book comprising:
(a) perforating a first set of a plurality of pages;
(b) perforating a second set of a plurality of pages;
(c) placing a first set of a plurality of pages in a stack with said second set of a plurality of pages
(d) stitching the first set of a plurality of pages and the second set of a plurality of pages together along the centerline
(e) folding the stack of pages in half along the centerline such that the said second set of a plurality of pages remains on the outside to create a folded booklet;
(f) drilling hole punches; and
(g) attaching a cover to the outside of the folded booklet.

12. A method of making a composition book comprising:
(a) perforating a first set of a plurality of pages;
(b) perforating a second set of a plurality of pages;
(c) placing a first set of a plurality of pages in a stack on top of said second set of a plurality of pages and placing this stack atop a cover;
(d) stitching said first set of a plurality of pages, said second set of a plurality of pages and said cover together along a centerline; and
(e) folding said stack at said centerline such that the cover remains on the outside of the book

13. The method of claim 12 further including a final step of drilling hole punches through the folded book.

14. (canceled)
